(19) United States
(12) Patent Application Publication
(10) Pub. No.: US 2008/0302851 A1
(43) Pub. Date: Dec. 11, 2008

(54) Fastening element attaching device

(75) Inventor: Hideyuki Ueno, Kanagawa (JP)

Correspondence Address: Patrick G. Burns;GREER, BURNS & CRAIN, LTD., Suite 2500, 300 South Wacker Drive, Chicago, IL, 60606, US

(73) Assignee: KOTEC'S CO., LTD.

(21) Appl. No.: 11/811,146

(22) Filed: Jun. 8, 2007

(51) Int. Cl. B25C 1/00

(52) U.S. Cl. 227/120

(57) ABSTRACT

A fastening element attaching device is provided which has a simple configuration but even if the fastening element group 12′ having a short length is used, and even when the used connection bar 11 is accidentally remained inside the closed passage 3, the remaining connection bar 11 can be easily picked up and take out from the closed passage 3.

A fastening element attaching device 10 is configured so that a remaining connection bar 11 which is formed after when at least some of said respective fastening elements 12 among the fastening element group 12′ have been detached therefrom, is discharged from a discharging orifice 6 provided at the most end portion 4 of a main body 2 of the device 10 through a closed passage 3, wherein, the fastening element attaching device 10 is further provided with a temporary pick-up portion establishing mechanism 5 arranged on at least one portion of the closed passage 3 so that the remaining connection bar 11 remained inside the closed passage 3 can be picked up.

### BACKGROUND OF THE INVENTION

1. Field of the Invention

The present invention relates to a fastening element attaching device and more particularly, relates to a fastening element attaching device provided with a temporary pick-up portion establishing mechanism to easily pick up a used connection bar from a closed passage when a used connection bar is remained inside a discharging closed passage and is impossible to be taken out therefrom.

2. Background of the Invention

As explained above, the present invention relates to a fastening element attaching device which is capable of binding up the clothes and socks or the like and attaching tags such as a brand label, a price tag, material explanation and direction for use or the like to the commodities by inserting the fastening elements into the commodities.

Generally, in order to bind up the clothes, the daily fancy goods, the slippers and the shoes or the like and effectively attach a brand label and a price tag or the like to the above commodities, various fastening element attaching devices have been conventionally used.

For example, according to the conventional fastening element attaching device, as shown in Japanese Unexamined Utility Model Application (KOKAI) No. 5-51715, (Patent Document No. 1) the device has a hollow needle which is attached to a front edge of a main body, a push rod which goes in and out from the foregoing hollow needle, a guide groove which is disposed on an entrance of the foregoing hollow needle, a fastening element feeding ratchet which is disposed on the entrance side of the foregoing hollow needle with facing to the foregoing guide groove, and a stopper which is disposed laterally right beside of the foregoing feeding ratchet, and in this device, an entrance portion and an exit portion of the foregoing guide groove are provided at a portion apart with some distance from the foregoing hollow needle and the length of the foregoing guide groove consists of a first length formed between the foregoing hollow needle entrance and an entrance portion of the foregoing guide groove and a second length formed between the foregoing hollow needle entrance and an exit portion of the guide groove, is set as long as possible.

And further, in the device, a plurality of fastening elements each being tentatively and length-wisely arranged and connected to each other by a connection bar so that these fastening elements are form into one body, is disposed on the device with the connection bar being inserted downwardly into the guide groove via the entrance portion of the guide groove which is formed on a top upper surface of the device.

Further, in this device, the lowest fastening element is always and successively pushed out into the hollow needle with being detached from the fastening element group by the lever operation.

Additionally, the connection bar, which remains inside the device after at least some of the fastening elements had been pushed out, is discharged from a front lower part of the main body of the device.

However, on the other hand, if the length of the fastening element group is longer, the above described conventional fastening element attaching device involves a problem such that when the fastening element is used for the commodities, for example, the clothes or the like, the connecting bar after the fastening elements have been removed therefrom, tears down the commodities after pushing out the fastening elements or it hurts a finger of the operator.

Especially, the connection bar after pushing out the fastening elements is very danger, since a trace formed after when the fastening elements had been taken out, is sharp.

Alternatively, there is a case that the connection bar itself, which extends longer in the upper direction or the lower direction in the front part of a main body of the device, becomes an obstacle against the operation.

However, on the other hand, in considering a manufacturing cost, the fastening element group is capable of being provided at a low price when the total length of the fastening element is made longer.

This is because the fastening element group is made by utilizing one metal mold.

Therefore, another fastening element attaching device has been proposed as shown in Japanese Unexamined Patent Publication (KOKAI) No. 2001-253419, (Patent Document No. 2) in which the fastening element attaching device is provided with a selecting mechanism which makes it possible to select a discharging position for an end portion of the connection bar of the fastening element to be selectively discharged from either one of a lower portion of the detaching operation executing portion or the most end portion of the main body of the fastening element attaching device.

However, it is usually complicated operation in which an operator in a working site, switches a switching lever or the like at every time when a length of the fastening element group to be used is changed so as to shift the discharging direction of the connection bar.

Accordingly, the following problems has been arisen, such as a working efficiency thereof is reduced and there are many cases in which such switching operation was not successful and thus a cost for adjusting the device or for disassembling and repairing the device has been added and finally such total production costs thereof has been increased.

Consequently, in order to overcome the above-mentioned problems, as well as to improve an external ornament thereof and to prevent further dangerous from being arisen, a separate fastening element attaching device recently has been used, in which an used connection bar is discharged from the most end portion of a main body of the fastening element attaching device by forming the discharging passage for the connection bar in a completely closed passage.

However, in the fastening element attaching device having the above-mentioned configuration, in a case in which a fastening element group the length of which being long is used, since it is apparent that the length of the connection bar is also long, even if when the connection bar becomes impossible to be discharged from the fastening element attaching device, during its discharging operation, there would be many cases in that a front end portion of the connection bar is already projected from a discharging aperture or the connection bar still engages with the detaching operation executing portion of the fastening element attaching device, it is possible for the connection bar to be taken out or picked up from the fastening element attaching device.

On the other hand, however, when the fastening element group the length of which is short, is used, since it is apparent that the length of the connection bar is also short, in a case in that after all of the fastening elements have been detached from the connection bar and the connection bar is remained inside of a closed passage with some reason, without the tip end portion of the connection bar being projected from the discharging aperture provided the most end portion of the fastening element attaching device, it is quite difficult to pick it up from the fastening element attaching device and further problem would be arisen in that disassembling the body of the fastening element attaching device must be required so as to pick up the same from the closed passage of the fastening element attaching device.

Further, the disassembling operation thereof needs a lots of time and complicated works, and accordingly, since only an expert operator can easily disassemble the fastening element attaching device and re-assemble the disassembled device, the problem is also increased or enlarged from an economical point of view.
(Patent Document No. 1) Japanese Unexamined Utility Model Publication (KOKAI) No. 5-51715
(Patent Document No. 2) Japanese Unexamined Patent Publication (KOKAI) No. 2001-253419,

### DISCLOSURE OF THE INVENTION

### Problem to be solved by the Invention

Accordingly, an object of the present invention is to overcome the above mentioned past problems and to provide a fastening element attaching device, which is capable of discharging a used connection bar from a discharging aperture provided on the most back side end portion of a fastening element attaching device and wherein even in using a fastening element group a length of which is shorter than that of a standard one, and even in a case when the used connection bar has been remained inside of the closed passage with some reason, it is very easy for an operator to easily pick up the connection bar which is retained inside the closed passage, therefrom.

### Means for Solving the Problem

In order to attain the above-mentioned object of the present invention, the present invention basically has the following technical constitution.

Note that, the present invention is fastening element attaching device for sequentially detaching respective fastening elements from a connection bar by an operational lever from among a fastening element group, in which a plurality of fastening elements are fixedly and integrally arranged in parallelism with each other by the connection bar, so as to attach the same to a desired good, and the device is further configured so that a remaining connection bar which is formed after when at least some of the respective fastening elements among the fastening element group have been detached therefrom, is discharged from a discharging orifice provided at the most end portion of a main body of the device through a closed passage, wherein the device is further provided with a temporary pick-up portion establishing mechanism arranged on at least one portion of the closed passage so that the remaining connection bar remained inside the closed passage can be picked up.

### EFFECT OF THE INVENTION

Since the fastening element attaching device of the present invention has the above-mentioned technical features, the used connection bar remaining inside the closed passage with some reason, can be easily picked up from the fastening element attaching device, and accordingly, in the present invention, a fastening element attaching device which an operator can use in a working site with high working efficiency, can be provided.

### BRIEF DESCRIPTION OF THE DRAWINGS

FIG. 1 is a side view for illustrating one embodiment of the fastening element attaching device of the present invention;

FIG. 2 is a perspective view for illustrating one embodiment of the fastening element group used in the present invention;

FIG. 3 is a side view for illustrating one embodiment of an operation mechanism used in the fastening element attaching device of the present invention;

FIG. 4 is a front view for illustrating one embodiment of the fastening element attaching device of the present invention;

FIG. 5 is views for illustrating one embodiment of a temporary pick-up portion establishing mechanism used in the present invention; and

FIG. 6 is a side elevation view for illustrating one embodiment of a detaching operation executing portion used in the present invention.

### BEST MODE FOR CARRYING OUT THE INVENTION

An embodiment of the fastening element attaching device according to the present invention will be explained below with reference to the drawings.

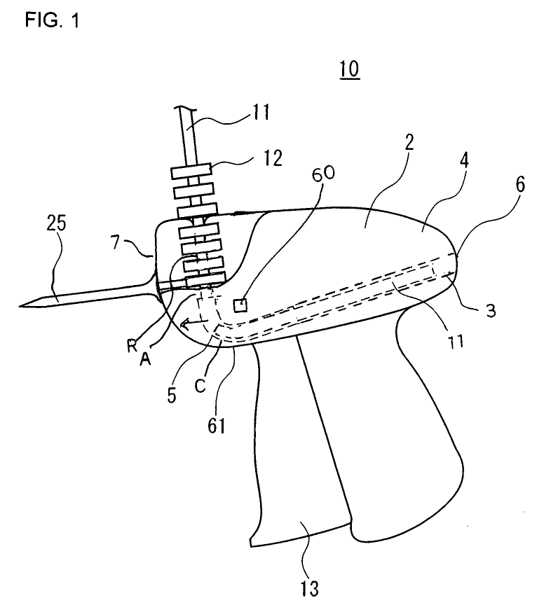

FIG. 1 illustrates a side elevation view showing a configuration of a specific embodiment of the fastening element attaching device of the present invention.

A fastening element attaching device 10 of the present invention 10 as shown in FIG. 1 is a device for sequentially detaching respective fastening elements 12 from a connection bar 11 by an operational lever 13 from among a fastening element group 12′, in which a plurality of fastening elements 12 are fixedly and integrally arranged in parallelism with each other by the connection bar 11.

By using the device 10, each of the fastening element 12 can be attached to a desired good and further the device 10 is configured so that a remaining connection bar 11 which is formed after when at least some of the respective fastening elements 12 among the fastening element group 12′ have been detached therefrom, is discharged from a discharging orifice 6 provided at the most end portion 4 of a main body 2 of the device 10 through a closed passage 3.

And further the fastening element attaching device 10 of the present invention is further provided with a temporary pick-up portion establishing mechanism 5 arranged on at least one portion of said closed passage 3 so that the remaining connection bar 11 remained inside said closed passage 3 can be picked up.

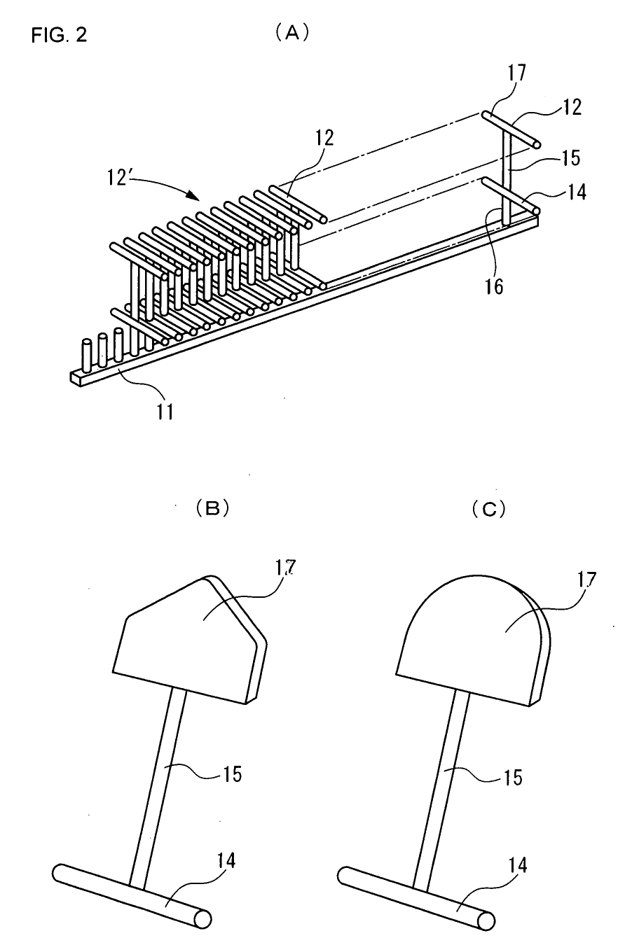

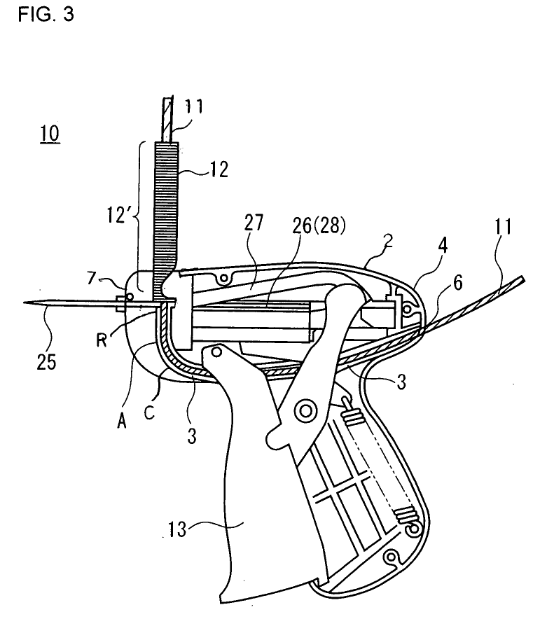

Now, a basic operation mechanism of the fastening element attaching device of the present invention will be explained hereunder with reference to FIGS. 2 and 3.

Note that, FIG. 2 shows a configuration of one embodiment of the fastening element group 12′ used in the present invention.

As shown in FIG. 2, the fastening element group 12′ comprises a plurality of fastening element 12 each being arranged in parallelism with each other and each one of the fastening element 12 is connected to a connection bar 11 via a suitable connecting means 16.

Further, each one of the fastening elements 12 comprises a head of fastening element 17 and an insertion engaging portion 14 which is connected to the head of fastening element 17 through a filament portion 15 and each one of them are integrally formed into one piece.

As explained hereunder, the respective insertion engaging portion 14 is detached from the connection bar 11 by a pushed out pin 26 at a detaching operation executing portion 28 and is penetrated through a desired good via an insertion needle 25 so that the insertion engaging portion 14 is attached to the good.

Note that, the configuration of the head of fastening element 17 of the fastening element attaching device 12 may be a rod like configuration as shown in FIG. 2 (A) but it may be other configuration as shown in FIG. 2 (B) and FIG. 2 (C).

On the other hand, one embodiment of an operation mechanism of the fastening element attaching device of the present invention is shown in FIG. 3.

And as shown in FIG. 3, the fastening element attaching device 10 of the present invention is provided with a detaching operation executing portion 28 which operates to move the push out pin 26 reciprocally with a lateral sliding manner in left and right directions by operating an operation lever 13 so that always the lowest fastening element 12 among the fastening element group 12′ in which a plurality of the fastening elements 12 are integrally formed into one piece with a connection bar 11, is sequentially pushed out.

And the fastening element attaching device 10 is further characterized in that in the device 10 of the present invention an used connection bar 11 from which all of the respective fastening elements 12 among the fastening element group 12′ have been detached from the connection bar 11, can be transferred from a position A just beneath the detaching operation executing portion 28 provided inside of a main body 2 of the fastening element attaching device 10, to the most rear end portion 4 of the main body 2 thereof via a closed passage 3 having a curved configuration so that it is discharged from a discharging orifice 6 provided at the most rear end portion 4 of the main body 2 of the fastening element attaching device 10.

On the other hand, at the most front end portion 7 of the main body 2 of the fastening element attaching device 10, there is provided a hollow needle 25, and the push out pin 26 inserted into the hollow needle 25 has a configuration in that it detaches the insertion engaging portion 14 of the lowest fastening element 12 in the fastening element group 12′ from the connection bar 11.

The fastening element group 12′ is mounted in an insertion groove R provided on the main body 2 and the push out pin 26 inserts the same into the hollow needle 25 so as to push out it.

Further, the fastening element attaching device 10 is preferably provided with a suitable feeding means (not shown in the drawings) which can sequentially feed each one of the fastening element 12 of the fastening element group 12′ downwardly one by one.

And the used connection bar 11 from which the fastening elements 12 have been detached and pushed out, is discharged from the discharging orifice 6 provided at the most rear end portion 4 of the main body 2 thereof into outside.

In the present invention, the discharging passage 3 for the connection bar 11 provided inside of the main body 2 of the fastening element attaching device 10 has a closed passage 3 which is connecting between the detaching operation executing portion 28 of the fastening element attaching device 10 and the most rear end portion 4 of the main body 2 thereof and thus no window or no aperture which connects between the closed passage 3 and external surface of the main body 2, is provided on the closed passage formed therebetween

And further note that a part of the closed passage 3 for discharging the used connection bar 11 has a curved configuration and accordingly, in the fastening element attaching device 10 of the present invention, the used connection bar 11 does not become an obstacle against the working operation of an operator and the working efficiency can be improved and there is no fear for the used connection bar 11 to give damages on a good.

Next, the temporary pick-up portion establishing mechanism 5 as used in the fastening element attaching device 10 of the present invention will be explained with reference to the drawings.

Note that, as shown in FIG. 3, the temporary pick-up portion establishing mechanism 5 of the present invention is provided at a portion C which is just beneath a position A at which the detaching operation executing portion 28 is provided and at which each one of the fastening elements 12 is sequentially detached from the connection bar 11 one by one, and at the portion C, the remaining connection bar 11 is changed its moving direction in the closed passage 3 so as to direct to the most rear end portion 4 of the main body 2 of the fastening element attaching device 10.

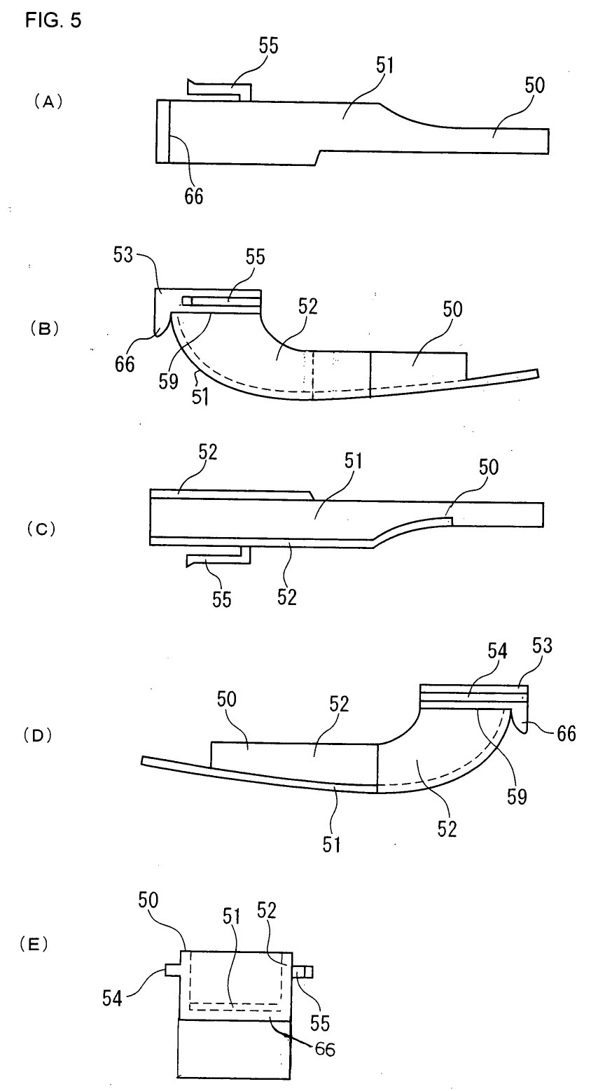

Further, as shown in FIG. 5, the temporary pick-up portion establishing mechanism 5 of the present invention, is preferably provided at least with a bottom plate portion 51 which corresponds to a part of a bottom plate of the closed passage 3 or with the bottom plate portion 51 and a side wall portion 52 which corresponds to a part of the side wall portion of the closed passage 3 and this temporary pick-up portion establishing mechanism 5 is preferably configured so that it is detachably connected to the closed passage 3 in response to a operation controlling means 60.

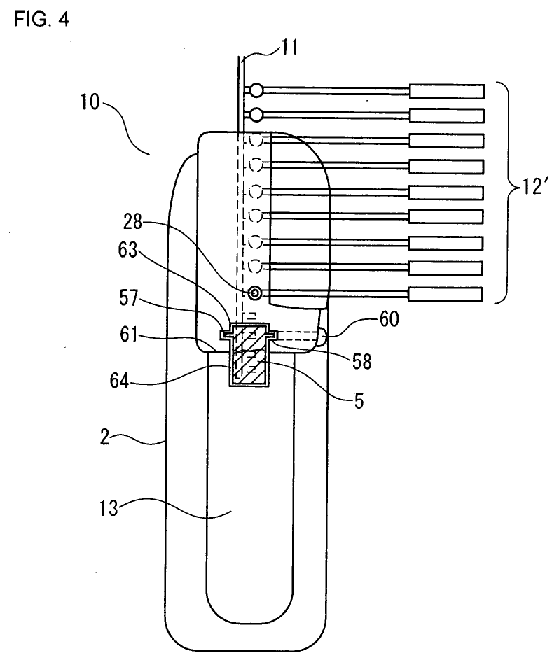

Further more, the temporary pick-up portion establishing mechanism 5 of the present invention, as shown in a front view of the fastening element attaching device 10 in FIG. 4 seeing the operational lever 13 from a front end of the fastening element attaching device 10, is preferably provided on a border portion 61 formed between the operational lever 13 of the fastening element attaching device and a main body 2 of the fastening element attaching device 10.

And it is also provided inside an aperture 64 formed at a position 63 bridging an upper end portion of the operational lever 13 of the fastening element attaching device 10 and a lower end portion of the main body 2 of the fastening element attaching device 10.

More specifically, in FIG. 4, an aperture 64 is provided at a position 63 located on the passage of the closed passage 3 to which the operation lever 13 is approached and in the vicinity of the detaching operation executing portion 28 of the main body 2 of the fastening element attaching device 10.

Note that the aperture 64 is provided at the position 63 bridging an upper end portion of the operational lever 13 and a lower end portion of the main body 2 of the fastening element attaching device 10, and though this aperture 64, the temporary pick-up portion establishing mechanism 5 is arranged slidably and detachably.

And further, it is one of preferable embodiments of the present invention that the temporary pick-up portion establishing mechanism 5 of the present invention, as shown in FIG. 5, comprises at least a part of a bottom plate portion 51 and/or a side wall portion 52 of the closed passage 3, and which can be removed from the closed passage 3 in response to an operation of the predetermined operation controlling means 60.

Note that the temporary pick-up portion establishing mechanism 5 consists a part of the closed passage 3.

In the present invention, for a separate embodiment other than the above-mentioned embodiment, the temporary pick-up portion establishing mechanism 5 which corresponds to a part of the bottom plate portion 51 and/or a part of the side wall portion 52 of the closed passage 3, is detachably and rotatably attached to a part of the main body 2 of the fastening element attaching device 10 utilizing a suitable hinge means.

In FIG. 5, one embodiment of the temporary pick-up portion establishing mechanism 5 is shown and in this embodiment, a suitable sliding grooves or sliding projections 57 58 are provided at an upper end portion the aperture 64, while a slidable member 50 which can meet with the aperture 64 is provided.

In the present invention, at a head portion 53 of the slidable member 50, a projecting portion or a groove portion 54, 55 each of which being slidably engaged with the sliding groove or sliding projection 57 58 of the aperture 64 are provided.

Further, successively, at a lower end portion 59 of the head portion 53, a curved bottom plate portion 51 which has a configuration substantially identical to the curved passage of the closed passage 3 and aside wall portion 52, are integrally provided and further this slidable member 50 is configured so that it is slidably detached from the fastening element attaching device 10 in response to the operation of the predetermined operation controlling means 60.

The wall portion 52 may be provided at least for a predetermined length along the bottom plate portion 51 from the lower end portion of the head portion 53 or may be provided along the overall length of the bottom plate portion 51.

On the other hand, at the lower end portion of the head portion 53, it can be provided only with the bottom plate portion 51.

Further in the present invention, it is another preferable embodiment in that at least one of the projecting portion or groove 54, 55 formed at the head portion 53 of the slidable member 50 is provided with a engaging hold member 63 which can engage with a stopper member 62 which is provided on the sliding groove or sliding projection 57, 58 formed in the main body 2 of the fastening element attaching device 10.

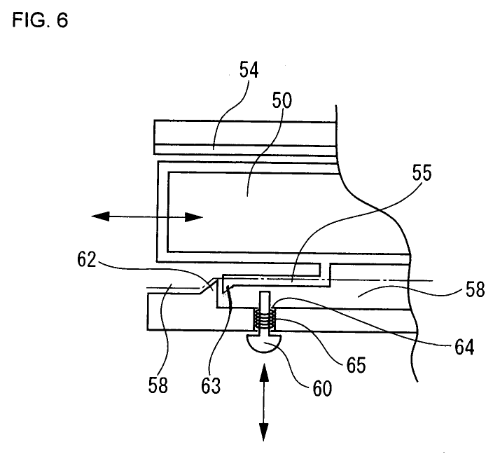

In the present invention, for example, as shown in FIG. 6, the operation controlling means 60 is provided on the main body 2 of the fastening element attaching device 10 and it has a function so that it can affect the engaging hold member 63 to release the engagement formed between the engaging hold member 63 and the stopper member 62.

More preferably, the operation controlling means 60 comprises a pressure button 64 having a suitable configuration which is provided inside an aperture 66 which is provided on a side surface of the main body 2 of the fastening element attaching device 10 via a suitable spring member 65.

In this embodiment, when the button 64 is pressed, a tip end portion of the pressure button 64 presses a portion in the vicinity of the engaging hold member 63 of the temporary pick-up portion establishing mechanism 5 to cause it displaced and thus the engagement between the stopper member 62 and the engaging hold member 63 is released.

By doing this, the temporary pick-up portion establishing mechanism 5 can be removed in a sliding manner from the fastening element attaching device 10 in a direction to front forward thereof.

Therefore, a pick up aperture 64 is opened at a portion of the closed passage 3 and thus an used connection bar 11 but remained inside the closed passage 3 with some reason and the picking up operation for it being difficult, can easily pick up from the aperture 64.

Further, after the pick up operation for the used connection bar 11 has been finished, the temporary pick-up portion establishing mechanism 5 can be easily inserted into the aperture 64 so as to reinstall the closed passage 3.

In addition to thereabove, in the present invention, when a pulling out engaging hook 66 is provided at a front end portion of the head portion 53 of the sliding member 50 facing to a pulling out direction, the pulling out operation of the temporary pick-up portion establishing mechanism 5 from the aperture 64 in a sliding manner can be further effective.

The present invention is not restricted to the above-mentioned embodiment but many different kinds of embodiments can be conceivable based upon the technical conception of the present invention.

Since the present invention adopts the above-mentioned technical configurations, even if the fastening element group 12′ having a short length is used, and even when the used connection bar 11 is accidentally remained inside the closed passage 3, the remaining used connection bar 11 can be easily picked up and take out from the closed passage 3.

And further, in the present invention, the operation for returning the temporary pick-up portion establishing mechanism 5 to the original position, is also very easy and thus the working efficiency is remarkably improved as well as the operator does not feel somewhat uneasy in using the device 10 in the working site and performs his work with high level of efficiency.

Further more, in the present invention, since the necessity for repairing or exchanging the fastening element attaching device 10 is not required, the working cost can be greatly reduced.

In addition thereabove, in the present invention, the fastening element group 12′ even having a short length can be used and since the connection bar 11 is discharged from the most rear end portion of the main body 2, the problem in that the good is damaged or a wrist or fingers of an operator is damaged by the connection bar 11, is not arisen.

### EXPLANATION OF SYMBOLS USED IN THIS SPECIFICATION

2 main body
3 closed passage
4 the most end portion
5 temporary pick-up portion establishing mechanism
6 discharging orifice
7 the most front end portion
10 fastening element attaching device
11 connection bar
12 fastening elements
12′ fastening element group
13 operational lever
14 insertion engaging portion
15 filament portion
16 connecting means
17 head of fastening element
25 insertion hollow needle
26 pushed out pin
28 detaching operation executing portion
50 slidable member
51 bottom plate portion
52 side wall portion
53 head portion
54 projecting portion or a
55 groove portion
57 sliding groove
58 sliding projection
59 lower end portion
60 operation controlling means
61 border portion
62 stopper member
63 engaging hold member
64 aperture
65 spring member
66 pulling out engaging hook

What is claimed is:

1. A fastening element attaching device for sequentially detaching respective fastening elements from a connection bar by an operational lever from among a fastening element group, in which a plurality of fastening elements are fixedly and integrally arranged in parallelism with each other by the connection bar, so as to attach the same to a desired good, and said device is further configured so that a remaining connection bar which is formed after when the most of said respective fastening elements among said fastening element group have been detached therefrom, is discharged from a discharging orifice provided at the most end portion of a main body of said device through a closed passage, wherein said device is further provided with a temporary pick-up portion establishing mechanism arranged on at least one portion of said closed passage so that said remaining connection bar remained inside said closed passage can be picked up.

2. A fastening element attaching device according to claim 1, wherein said temporary pick-up portion establishing mechanism is provided at a location beneath a detaching operation executing portion in which each one of said fastening elements is detached from said connection bar, and in the vicinity of a position at which said connection bar is changed its moving direction in said closed passage to said discharging orifice provided at the most end portion of said device.

3. A fastening element attaching device according to claim 1 or 2, wherein said temporary pick-up portion establishing mechanism is configured so that at least a part of a side wall portion or a bottom plate portion which consisting a part of said closed passage is detachably attached to said closed passage in response to an activation of a predetermined operation controlling means.

4. A fastening element attaching device according to any one of claims 1 to 3, wherein said temporary pick-up portion establishing mechanism is provided on a border portion formed between said operational lever of said fastening element attaching device and a main body of said fastening element attaching device, and is provided inside an aperture formed at a position bridging an upper end portion of said operational lever of said fastening element attaching device and a lower end portion of said main body of said fastening element attaching device, seeing said operational lever from a front end of said fastening element attaching device.

5. A fastening element attaching device according to claim 3 or 4, wherein said temporary pick-up portion establishing mechanism is configured so that a member corresponding to a portion at least consisting a part of said bottom plate portion of said closed passage or a part of said bottom plate portion and a part of said side wall portion of said closed passage is separated from said closed passage in response to an operation of said operation controlling means.

6. A fastening element attaching device according to claim 4, wherein said temporary pick-up portion establishing mechanism comprises a sliding groove portion or a sliding projecting portion which is provided in the vicinity of an upper end portion of said aperture and inside of said main body of said fastening element attaching device, and a sliding member which can meet with said aperture and can slide inside said aperture, and wherein, a projecting portion or a groove portion which can slideably meet with said sliding groove portion or a sliding projecting portion is provided on a head portion of said side wall portion of said sliding member, and further wherein, said sliding member is integrally provided with a curved bottom plate portion, the configuration of which being substantially identical to a configuration of said closed passage at a lower end portion of said head portion, and further wherein said sliding member is configured so that it can be slideably separated from said main body of said fastening element attaching device in response to an operation of said operation controlling means.

7. A fastening element attaching device according to claim 6, wherein said sliding member is provided with a pulling out engaging hook at a front end portion of said head portion thereof facing to a pulling out direction.

8. A fastening element attaching device according to claim 7, wherein an engaging hold member is provided on at least a part of said projected portion or said groove portion formed on said head portion of said sliding member, said engaging hold member can be engaged with a stopper member provided on said sliding groove portion or said sliding projection portion provided inside of said main body of said fastening element attaching device.

9. A fastening element attaching device according to claim 8, wherein said operation controlling means is provided on said main portion of said fastening element attaching device, and wherein said operation controlling means having a function to release an engagement condition formed between said engaging hold member and said stopper member portion.
